(19) United States
(12) Patent Application Publication
(10) Pub. No.: US 2013/0334159 A1
(43) Pub. Date: Dec. 19, 2013

(54) LATTICE STRUCTURE

(71) Applicant: Kamal DAAS, Tira Triengle (IL)

(72) Inventors: Kamal Daas, Tira Triengle (IL); Doron Livnat, Rotterdam (NL)

(21) Appl. No.: 13/985,766

(22) PCT Filed: Feb. 1, 2012
(86) PCT No.: PCT/EP2012/000448

§ 371 Date: Aug. 15, 2013

(30) Foreign Application Priority Data
Feb. 18, 2011 (DE) 202011002901.8

(51) Int. Cl. B66C 23/68

(52) U.S. Cl. CPC B66C 23/68
USPC 212/299; 52/646

(57) ABSTRACT

A lattice structure which is movable to and fro between a condition folded out and a condition folded in, wherein the lattice structure includes props extending in longitudinal direction of the lattice structure and wherein the lattice structure furthermore includes struts which connect said props with each other. According to the invention, at least one of the struts has at least one joint about which at least two portions of the strut are pivotable relative to each other, and that at least one of the struts has no such joint.

The present invention relates to a lattice structure which is movable to and fro between a condition folded out and a condition folded in, wherein the lattice structure includes props extending in longitudinal direction of the lattice structure and wherein the lattice structure furthermore includes struts which connect said props with each other.

From the prior art, so-called lattice structures are known, which include longitudinally extending props which in the condition of the lattice structure folded out are connected with each other by obliquely extending struts. The arrangement of the struts is solved such that the distance of the props extending in longitudinal direction of the lattice structure is reducible and increasable, so that the lattice structure can be folded in and folded out, which preferably also applies for the lattice structure of the present invention. This is important in particular for transport purposes, as in the condition folded in the lattice structure requires relatively little space and therefore can be transported easily.

It is the object underlying the present invention to develop a lattice structure as mentioned above to the effect that the same has a comparatively simple construction and nevertheless provides for an easy folding in and folding out.

This object is solved by a lattice structure with the features of claim 1. Accordingly, it is provided that at least one of the struts has at least one joint (subsequently also referred to as joint struts) about which at least two portions of the strut are pivotable relative to each other, and that at least one of the struts has no such joint and preferably no joint at all. According to the invention, two types of strut thus are used, of which the one type has at least one joint and of which the other type has no such joint, preferably no joint at all.

Preferably, both the joint struts and the struts without a joint are pivotally connected with said props.

Thus, it is conceivable to design the struts on the one hand as joint struts and on the other hand as rigid rods, i.e. rods not formed with a joint.

This design of a lattice structure results in a comparatively simple construction. Nevertheless, folding in and out is easily possible.

It is particularly preferred when the struts are arranged such that they connect props with each other which are adjacent to each other in circumferential direction of the lattice structure. Alternatively or in addition, it can be provided that struts are arranged such that they connect props with each other which are not adjacent to each other in circumferential direction of the lattice structure, but for example are arranged diagonally opposed.

It is furthermore conceivable that in longitudinal direction of the lattice structure struts which have at least one joint follow struts which have no such joint or no joint at all. Hence it is possible that the struts which each connect two props with each other are arranged such that joint struts and struts without joint alternately follow each other. A grouping of joint struts and struts without joint also is conceivable, which means that several joint struts follow each other and/or several joints without strut follow each other.

Furthermore, it is possible that the joint is formed such that the portions of the strut connected by the joint are movable in one direction only. In a preferred embodiment, the joints thus are designed such that proceeding from their position which they take with a lattice structure folded out the struts can be folded in one direction only.

In the condition of the lattice structure folded out, the joint struts preferably have an elongated shape, i.e. the portions of the strut connected by the joint extend in one line.

The joint can be formed such that it forms a stop which limits the swivel movement of the portions of the strut connected by the joint. A maximum possible swivel angle of the portions of the strut connected by the joint can be about 180°, for example.

Preferably, it is provided that the struts which have no such joint are formed as rigid rods, which preferably are formed straight.

The struts which have said joint can have exactly one joint or also two or more than two joints per strut. When exactly one joint is provided, it is conceivable to arrange the same at the strut in the center or approximately centrally or also offset to the center of the strut.

Furthermore, it can be provided that the joint or joints of all struts are formed identical and/or are formed such that they permit a swivel movement of the portions of the struts connected by the joint for all of the struts having at least one joint in the same longitudinal direction of the lattice structure. It is conceivable, for example, that the portions of the struts connected by the joint all extend upward or all extend downward during or after folding the lattice structure together.

It is furthermore conceivable that in the condition of the lattice structure folded out at least one or more or all of the struts extend at an angle to the struts which differs from a 90° angle.

In principle, it is also possible that struts are provided which in the condition folded out extend at right angles to the props.

In a further aspect of the invention it is provided that two struts each are arranged at, preferably articulated to the props adjacent to each other.

Furthermore, it is conceivable that at least in the condition of the lattice structure folded out two adjacent struts extend at different angles relative to the prop at which they are arranged. Preferably, the struts connecting two props assume a zig-zag shape in the condition of the lattice structure folded out.

In a further aspect of the invention it is provided that along the entire length, preferably with the exception of an end region of the lattice structure, the struts do not extend in the interior space of the lattice structure defined by the props. These struts thus form the circumferential surface of the lattice structure. However, the invention also comprises the case that struts extend in said interior space of the lattice structure folded out or that in one or both end regions struts are provided, which extend over the interior space or through the same.

A particularly simple, but nevertheless stable construction is obtained when in the interior space of the lattice structure folded out, which is defined by the props, no further struts or other construction elements are arranged.

Furthermore, it is conceivable that at least one, preferably several or all of the joints are formed such that they include locking means or can be provided with locking means, by means of which the joint position can be fixed and/or the movement of the joint can be limited. Such locking means for example can be a bolt or the like, which can be connected with the joint such that in its end position, preferably with the lattice structure folded out, the joint is fixed and can no longer be moved.

In at least one portion, preferably in at least one end region of the lattice structure struts can be arranged, which connect two non-adjacent props with each other and preferably are arranged crosswise.

In its end region, preferably in the end region or in both end regions of one, several or all props, the lattice structure can include connecting elements with which it is connectable with a further lattice structure or with some other structure like a carrier or a tip.

A preferred application of the lattice structure consists in that it is used as crane or as part of a crane or a crane boom, preferably of a truck crane.

Further details and advantages of the invention will be explained in detail with reference to an exemplary embodiment illustrated in the drawing, in which:

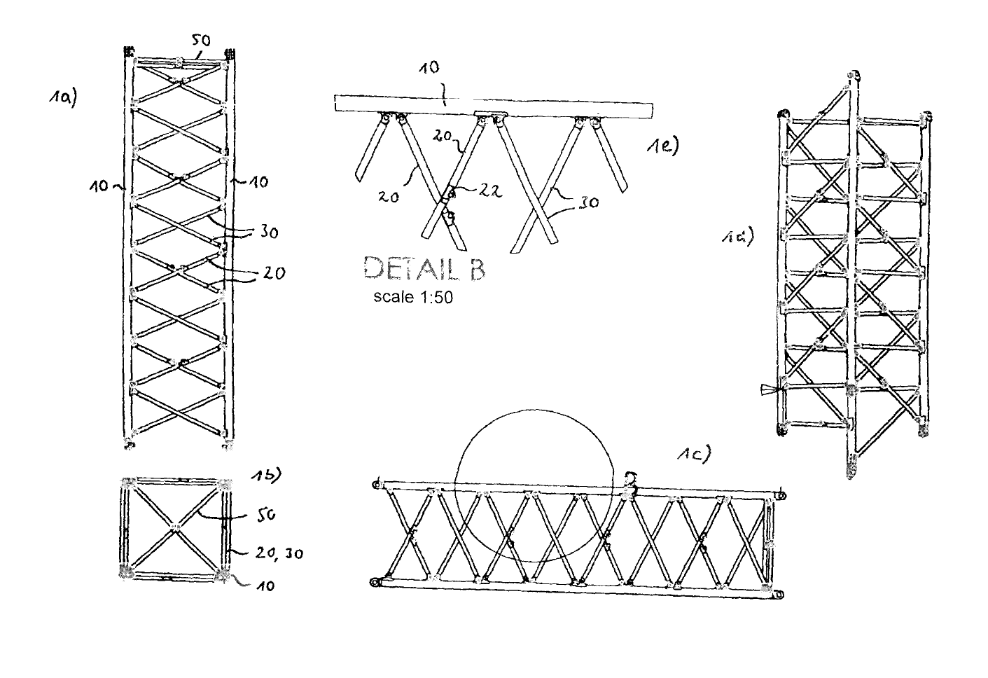

FIG. 1: shows different views of the lattice structure according to the invention in the condition folded out, and

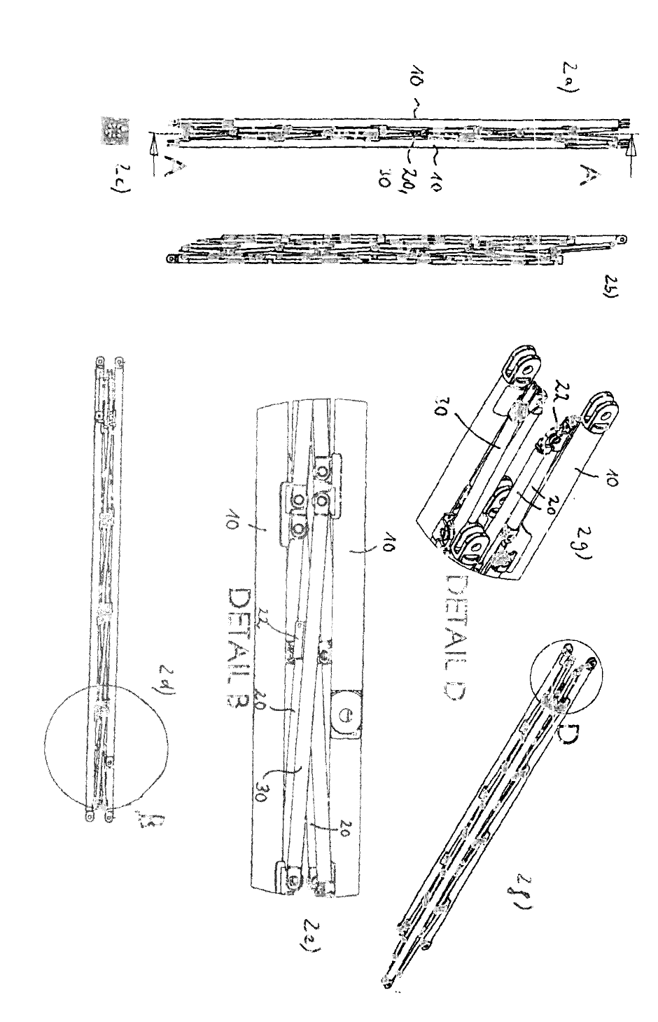

FIG. 2: shows different views of the lattice structure according to the invention in the condition folded in.

FIG. 1a) shows a side view of a lattice structure according to the invention, consisting of props 10 extending in longitudinal direction of the lattice structure, which in the top view represent the corner points of the lattice structure.

In the exemplary embodiment shown here, the lattice structure in the condition folded out is quadrangular (cf. FIG. 1b) or square or rectangular in cross-section. However, structures such as triangular variants or also designs with more than four props, which have a polygonal cross-section, also are conceivable.

FIG. 1c) shows the lattice structure in a side view in the lying condition and FIG. 1d) in a perspective view. FIG. 1e) is a detail view of the detail B of FIG. 1c).

As can be taken from the Figures, two adjacent props of the lattice structure each are connected by struts 20, 30, wherein in the condition folded out the struts 20, 30 extend at an angle to the prop 10, which differs from a 90° angle.

It can be taken from the view of FIG. 1a that struts 20, 30 succeeding each other extend in a zig-zag pattern between two adjacent props 10, i.e. are arranged to alternately ascend from the right to the left or to ascend from the left to the right.

As is furthermore shown in FIG. 1, with reference to two adjacent props 10, the struts 20, 30 connecting the same are not formed identical, but consist of two types of which the one type is designed as rigid rod 30, i.e. as rod having no joint, and the other type is designed as rod 20 which centrally or offset to the rod center has a joint 22.

This applies for all struts which connect two adjacent props 10, i.e. form the outer surfaces of the lattice structure.

The joint 22 of all struts 20 is formed such that when folding the lattice structure together, the strut portions which are connected by the joint 22 are pivoted in the same direction, i.e. according to FIG. 1 all of them upwards or all of them downwards.

As can be taken in particular from FIG. 1e), the struts 20 and 30 are pivotally arranged at or articulated to the props 10.

Reference numeral 50 designates struts which connect diagonally opposed props 10, as can be taken in particular from FIG. 1b). In the illustrated exemplary embodiment two of such struts 50 are provided, which in the condition of the lattice structure folded out extend crosswise.

These struts 50 like the struts 20 also each have a joint.

In the Figures it is furthermore illustrated that in the condition folded out the lattice structure has no other struts, props or other construction elements which extend in the interior space, which on the outside is defined by the props 10 and by the struts 20, 30. In the condition folded out the lattice structure thus is “hollow”, so to speak. However, this does not exclude that in particular in one or both end regions struts 50 extend, which extend in this interior space or adjoin the same.

FIG. 2 shows the lattice structure in the condition folded in, at which the side length of the cross-section as shown in FIG. 1b) is reduced to about ⅕.

FIG. 2a) shows the lattice structure in a side view, FIG. 2b) as sectional view according to the section A-A of FIG. 2a), FIG. 2c) in a top view, FIG. 2d) in a side view in a lying position, FIG. 2e) shows the detail B of FIG. 2d), FIG. 2f) shows the lattice structure in a perspective view, and FIG. 2g) shows the detail D of FIG. 2f).

For reasons of better clarity, the elements of the lattice structure shown in FIGS. 1 and 2 only partly are provided with reference numerals.

Due to the fact that the struts 30 have no joint and therefore do not experience a reduction in their length dimension when the lattice structure is folded in, the props 10 are shifted relative to each other in longitudinal direction of the lattice structure, when the lattice structure is folded together, and hence there is a slight increase in length of the lattice structure.

1. A lattice structure which is movable between a condition folded out and a condition folded in, wherein the lattice structure comprises props extending in longitudinal direction of the lattice structure and first struts and second struts which connect said props with each other, wherein at least one of the first struts has at least one joint about which at least two portions of the first strut are pivotable relative to each other, and that at least one of the second struts has no such joint.

2. The lattice structure according to claim 1, wherein the first and second struts are arranged such that they connect the props adjacent to each other in circumferential direction of the lattice structure and/or that the first and second struts are arranged such that they connect the props with each other, which are not adjacent to each other in circumferential direction of the lattice structure.

3. The lattice structure according to claim 1, wherein in the longitudinal direction of the lattice structure, the first struts which have said joint are arranged in alternation with the second struts which have no such joint.

4. The lattice structure according to claim 1, wherein the joint is formed such that the portions of the first strut connected by the joint are movable in one direction only.

5. The lattice structure according to claim 1, wherein the joint is formed such that the joint forms a stop which limits the swivel movement of the portions of the first strut connected by the joint.

6. The lattice structure according to claim 5, wherein said stop is formed such that the maximum possible swivel angle of the portions of the first strut connected by the joint is 180°.

7. The lattice structure claim 1, wherein the second struts which have no such joint are formed as rigid rods.

8. The lattice structure according to claim 1, wherein the first struts which have said joint have exactly one joint or two or more than two joints per the first strut.

9. The lattice structure according to claim 1, wherein the joint or joints of all the first struts are formed identical and/or are formed such that they permit a swivel movement of the portions of the first struts connected by the joint for all of the first struts having at least one joint only in the same longitudinal direction of the lattice structure.

10. The lattice structure according to claim 1, wherein in the condition of the lattice structure folded out at least one or more or all of the first and second struts extend at an angle to the props which differs from a 90° angle.

11. The lattice structure according to claim 1, further comprising third struts, which in the condition folded out extend at right angles to the props.

12. The lattice structure according to claim 1, wherein two first and second struts each are articulated to the props adjacent to each other.

13. The lattice structure according to claim 1, wherein at least in the condition of the lattice structure folded out two adjacent first and second struts extend at different angles relative to the prop at which they are arranged.

14. The lattice structure according to claim 1, wherein along the entire length of the lattice structure, preferably with the exception of an end region of the lattice structure, the first and second struts do not extend in the interior space of the lattice structure defined by the props.

15. The lattice structure according to claim 1, wherein in the interior space of the lattice structure defined b the props no further struts or other construction elements are arranged.

16. The lattice structure according to claim 1, wherein at least one of the joints are formed such that they include locking means by means of which the joint position can be fixed and/or the movement of the joint can be limited.

17. The lattice structure according to claim 1, wherein in at least one portion, preferably in at least one end region of the lattice structure the third struts are arranged, which connect two non-adjacent props with each other and preferably are arranged crosswise.

18. A crane with at least one lattice structure according claim 1.

19. The crane according to claim 18, wherein the crane includes at least one boom which is partly or completely formed by a lattice structure according to claim 1.
